(19) United States
(12) Patent Application Publication
(10) Pub. No.: US 2025/0075767 A1
(43) Pub. Date: Mar. 6, 2025

(54) LASER HARDENING LOW-CARBON STEEL DAMPER TUBES

(71) Applicant: BeijingWest Industries Co., Ltd., Beijing (CN)

(72) Inventors: Frank Gerard PIRRELLO, Dayton, OH (US); James Louis LOPEZ, JR., Dayton, OH (US); Michael James CHISOM, Springboro, OH (US); Tania TANNAHILL, Englewood, OH (US); Steven Edward PYLE, New Lebanon, OH (US)

(21) Appl. No.: 18/461,365

(22) Filed: Sep. 5, 2023

(51) Int. Cl. F16F 9/06; C21D 1/09

(52) U.S. Cl. CPC F16F 9/061; C21D 1/09; F16F 9/064; F16F 2224/0208; F16F 2226/023; F16F 2230/0023

(57) ABSTRACT

A damper assembly includes a damper tube having a tubular shape defining an inner surface and extending for an axial length. The damper assembly also includes a rod disposed at least partially within the damper tube, and a piston connected to the rod and slidably disposed within the damper tube and configured to contact the inner surface of the damper tube along a stroke region less than the axial length. The inner surface of the damper tube includes a hardened surface including martensite and extending along the stroke region and less than the axial length of the damper tube. A method of treating a damper tube includes directing a laser beam onto an inner surface of the damper tube along a stroke region and less than an axial length of the damper tube and to cause steel of the inner surface of the damper tube to form a hardened surface.

### BACKGROUND OF THE INVENTION

### 1. Field of the Invention

The present invention generally relates to a damper assembly for a vehicle.

### 2. Description of the Prior Art

Damper assemblies are well known in the art for use in a vehicle. US2001025753 discloses a damper assembly comprising a damper tube in which a piston rod is mounted in an axially adjustable fashion. A piston is connected to an end of the piston rod within the damper tube and separates a compression chamber from a rebound chamber.

Damper tubes for damper assemblies, such as magnetorheological (MR) fluid damper may be made of mild steel. Such damper tubes include an inner surface that must be resilient to provide sealing contact with the piston and to prevent excess wear that can accumulate over a lifetime of service use. The inner surface of damper tubes may be chrome plated to provide the wear resistance required for service in a damper assembly for a vehicle suspension.

However, chrome plating is a relatively expensive process and includes the use of chemicals that can present environmental challenges if not properly handled and disposed. Chrome plating of damper tubes includes several steps including degreasing, and submersion in a chrome plating bath. An electrical current may be applied to create a desired chrome thickness. If the tubes are not properly degreased, the chrome coating can develop poor adhesion or pits which with affect performance. If the chrome plating bath is not properly maintained or the electrical current is not evenly distributed, there can be inconsistency in the coating thickness. Handling and disposal of the acidic chrome plating bath can present significant environmental challenges.

It is an object of the present disclosure to provide a hydraulic damper with a hardened inner surface, and which does not involve chrome plating the inner surface.

### SUMMARY OF THE INVENTION

The present invention provides a damper assembly. The damper assembly includes a damper tube having a tubular shape defining an inner surface and extending for an axial length. The damper assembly also includes a rod disposed at least partially within the damper tube; and a piston connected to the rod and slidably disposed within the damper tube and configured to contact the inner surface of the damper tube along a stroke region less than the axial length. The inner surface of the damper tube includes a hardened surface including martensite and extending along the stroke region and less than the axial length of the damper tube.

The present disclosure also provides a method of treating a damper tube. The method includes: generating a laser beam; directing the laser beam onto an inner surface of the damper tube to heat the inner surface to an elevated temperature sufficient to cause steel of the inner surface of the damper tube to form austenite; and cooling the austenite to form a hardened surface including martensite. Directing the laser beam onto the inner surface of the damper tube includes directing the laser beam along a stroke region and less than an axial length of the damper tube.

### BRIEF DESCRIPTION OF THE DRAWINGS

Other advantages of the present invention will be readily appreciated, as the same becomes better understood by reference to the following detailed description when considered in connection with the accompanying drawings.

FIG. 1 shows a cross-section of a damper assembly;

FIG. 2 shows a perspective cut-away view of a damper tube, in accordance with an aspect of the present disclosure;

FIG. 3 shows a cut-away side view of the damper tube of FIG. 2;

FIG. 4 shows a cross-sectional fragmentary view of the an inner surface of the damper tube of FIG. 2;

FIG. 5 shows a schematic diagram of a system for laser hardening an inner surface of a damper tube, in accordance with an aspect of the present disclosure; and

FIG. 6 shows a flow chart listing steps in a method for laser hardening an inner surface of a damper tube, in accordance with an aspect of the present disclosure.

### DESCRIPTION OF THE ENABLING EMBODIMENTS

Referring to the Figures, wherein like numerals indicate corresponding parts throughout the several views, it is one aspect of the present invention to provide a damper tube with an inner surface that is hardened to provide wear resistance for use in a magnetorheological (MR) damper, and without chrome plating.

The device and method of the present disclosure includes using a laser hardening process on the inner surface of a low-carbon steel tube for use as a damper tube in a damper assembly, such as an MR damper that contains an MR fluid. MR fluid may contain components that are abrasive and which can cause wear on an inner surface of the damper tube, especially along a stroke region where a piston contacts the inner surface tube.

A laser beam is directed onto the low-carbon tube and heats the tube in a localized area. This elevated temperature makes the carbon atoms in the steel rearrange to an austenite form on the surface of the steel. When the laser energy is removed, the tube will then self-quench and form a desired martensite form with hardness sufficient to provide resistance against wear that may otherwise be caused by sliding friction from contact with a piston. This martensite microstructure will increase the microhardness of the surface. The device and method of the present disclosure provides damper tubes with an inner surface that is hardened in a specific pattern that would allow for optimal wear resistance, and without plating the surface with a metal coating.

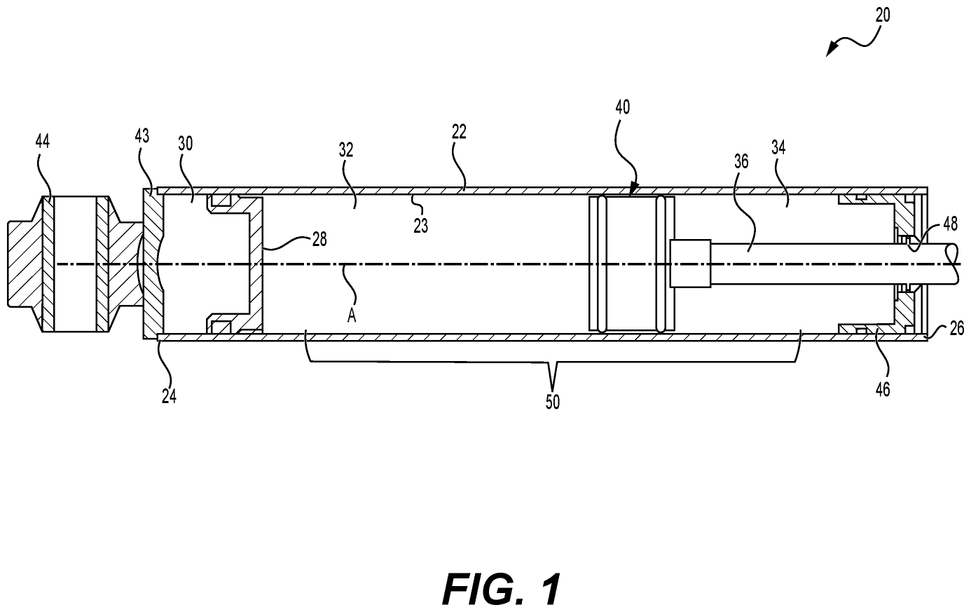

FIG. 1 shows a cross-section of a damper assembly 20 including a damper tube 22 that defines an inner surface 23. The damper tube 22 has a tubular shape and extends about an axis A and for an axial length between a first end 24 and a second end 26. The damper tube 22 may be made of a low-carbon steel. In some embodiments, the damper tube 22 may have a carbon content of between about 0.05% to about 0.3% by weight. In some embodiments, the damper tube 22 may have a carbon content of between about 0.3% to about 0.5% by weight.

The damper assembly 20 also includes a rod 36 that is disposed at least partially within the damper tube 22, and a piston 40 that is connected to the rod 36 and slidably disposed within the damper tube 22. The damper tube 22 defines a fluid chamber 32, 34 that contains a liquid, such as oil. The piston 40 divides the fluid chamber 32, 34 into a compression chamber 32 and a rebound chamber 34. In some embodiments, the piston 40 regulates fluid flow between the compression chamber 32 and the rebound chamber 34 to generate damping force in either or both of a rebound stroke and/or a compression stroke. In some embodiments, the fluid chamber 32, 34 is filled with an MR fluid having a viscosity that can be varied by application of a magnetic field. However, the fluid chamber 32, 34 may alternatively be filled with a non-MR fluid, such as oil without MR components.

The piston 40 is configured to contact and to seal against the inner surface 23 of the damper tube 22 along a stroke region 50 that is less than the axial length of the damper tube 22. For example, and as shown in FIG. 1, the stroke region 50 may be spaced apart from each of the first end 24 and the second end 26 of the damper tube 22.

The damper assembly 20 also includes a gas cup 28 that separates the compression chamber 32 from a gas compartment 30 containing a gas. The damper assembly 20 also includes a first closure 43 is located at the first end 24 of the damper tube 22. The first closure 43 encloses the gas compartment 30. A damper mount 44 is attached to the first closure 43 for securement to a vehicle component, such as suspension component or a fixed chassis structure. The damper assembly 20 also includes a second closure 46 disposed adjacent to the second end 26 of the damper tube 22 to enclose the rebound chamber 34. The second closure 46 defines a bore 48 for the rod 36 to pass through. The second closure 46 may provide a fluid-tight seal with the rod 36 to prevent fluid from leaking out of the rebound chamber 34.

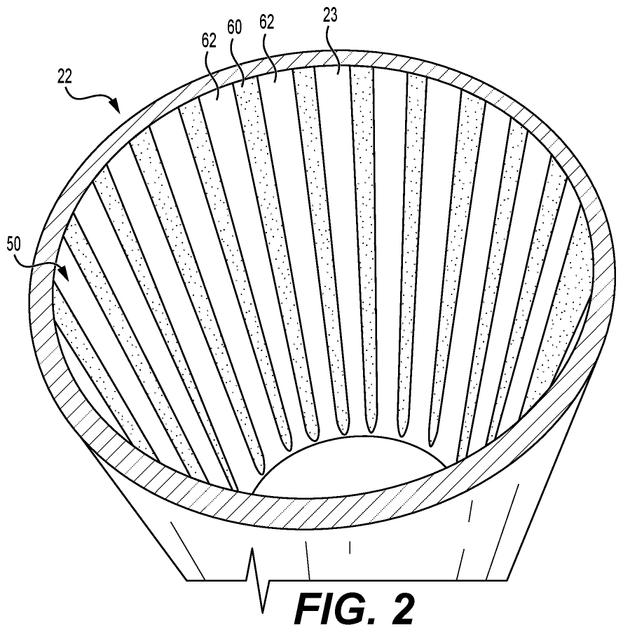

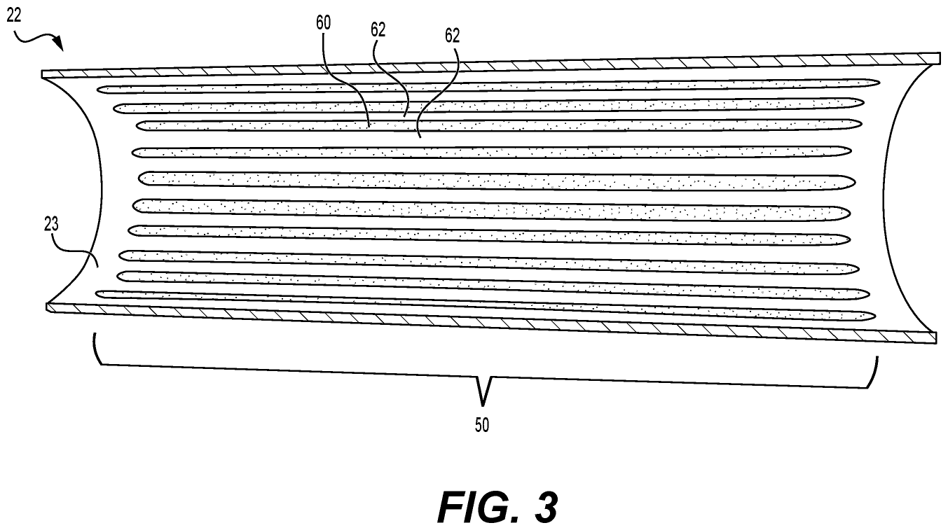

FIGS. 2-3 each show views of the inner surface 23 damper tube 22, and showing a plurality of bands 60 each defining a hardened surface that extends along the stroke region 50 of the inner surface 23 of the damper tube 22. The bands 60 extend parallel to and spaced apart from one another, with regions of non-hardened material between adjacent ones of the bands 60. However, the bands 60 may have another arrangement, such as an intersecting pattern or a continuous fill. As shown, the bands 60 each extend in an axial direction. Additionally or alternatively, one or more of the bands 60 may extend annularly around the inner surface 23 damper tube 22 and/or in a helical or spiral pattern. In some embodiments, the bands 60 may intersect one-another. For example, the inner surface 23 of the damper tube 22 may include two or more sets of the bands 60 intersecting one-another to define a cross-hatch pattern. The bands 60 may include martensite, which is a relatively hard form of steel, and which resists wear due to sliding contact with the piston 40. The bands 60 may have a hardness rating that is sufficient to provide the desired wear resistance to maintain the inner surface 23 in an operable condition over a service life of the damper assembly 20. The bands 60 may have a Rockwell Hardness of at least about RC 49. For example, the bands 60 may have a Rockwell Hardness of between RC 48 and RC 50. The bands 60 may be formed by laser heating an austenite steel then quickly self-quenching to form the martensite. In other words, removal of the laser heating may cause a local region of the damper tube 22 to cool relatively quickly and to form the martensite. Alternatively or additionally, a supplemental coolant may be used, such as a liquid or a gaseous coolant that may remove heat from the bands 60 after the laser heating.

FIGS. 2-3 each show the bands 60 being disposed at regular angular intervals extending circumferentially around the inner surface 23 damper tube 22 and separated by second bands 62 of non-hardened material, such as low-carbon steel that was not subjected to a heat treatment.

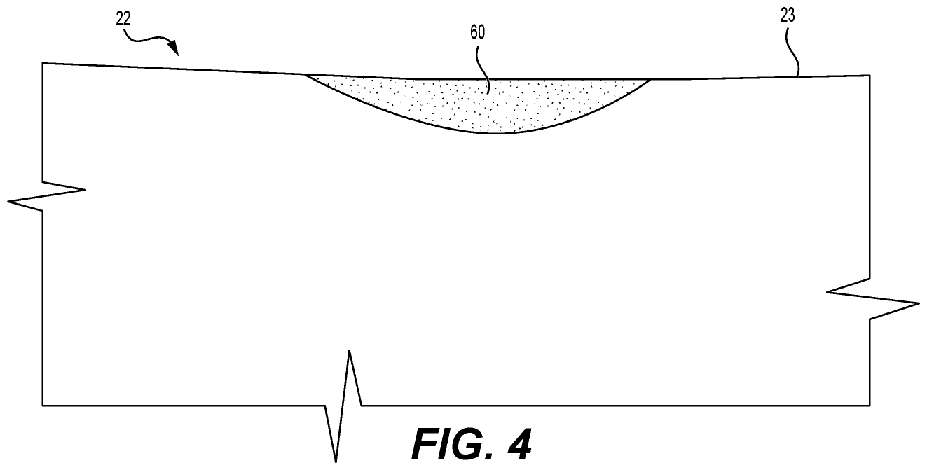

FIG. 4 shows a cross-sectional fragmentary view of the inner surface 23 of the damper tube 22, showing the axial band 60 of the hardened material that extends into the damper tube 22 and beneath the inner surface 23.

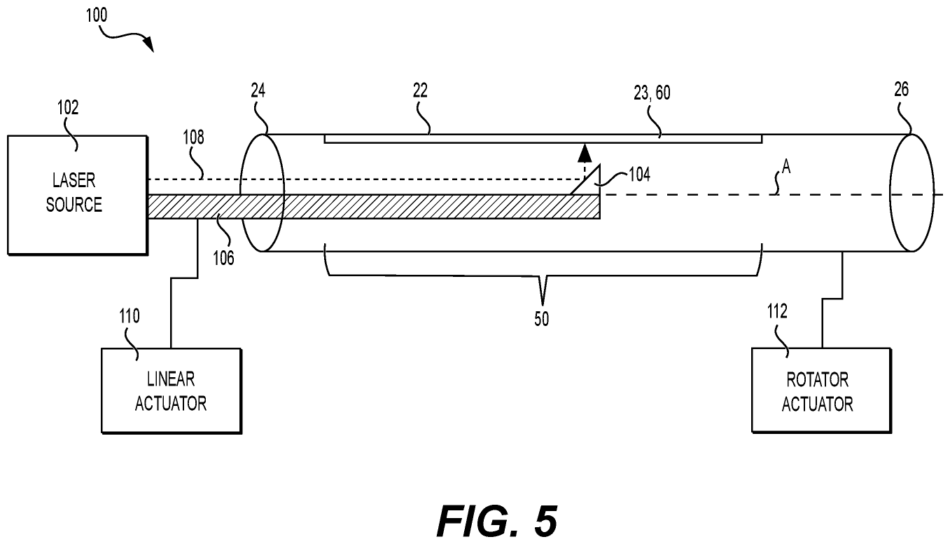

FIG. 5 shows a schematic diagram of a system 100 for laser hardening an inner surface 23 of a damper tube 22. The system 100 includes a laser source 102, such as a carbon dioxide laser, configured to generate a laser beam 108. The system 100 also includes a reflector 104, such as a mirror or a prism, that is attached to a beam 106 and configured to be placed within the damper tube 22 and to direct the laser beam 108 onto the inner surface 23 of the damper tube 22.

In some embodiments, and as shown in FIG. 5, the system 100 includes a linear actuator 110 configured to move the beam 106 and the reflector 104 in an axial direction to cause the laser beam 108 to be directed along the stroke region 50 and to form each of the plurality of bands 60 extending along an axial length of the damper tube. For example, the bands 60 may be formed in an axial path, as shown in FIG. 2 or in a helical path. Alternatively or additionally, the damper tube 22 can be moved in an axial direction to cause the laser beam 108 to form each of the plurality of bands 60 along the stroke region 50.

In some embodiments, and as shown in FIG. 5, the system 100 includes a rotator actuator 112 configured to rotate the damper tube 22 by a fixed angle to form each of the plurality of bands 60. Alternatively or additionally, the reflector 104 can be rotated about the axis A to form each of the plurality of bands 60 along the stroke region 50.

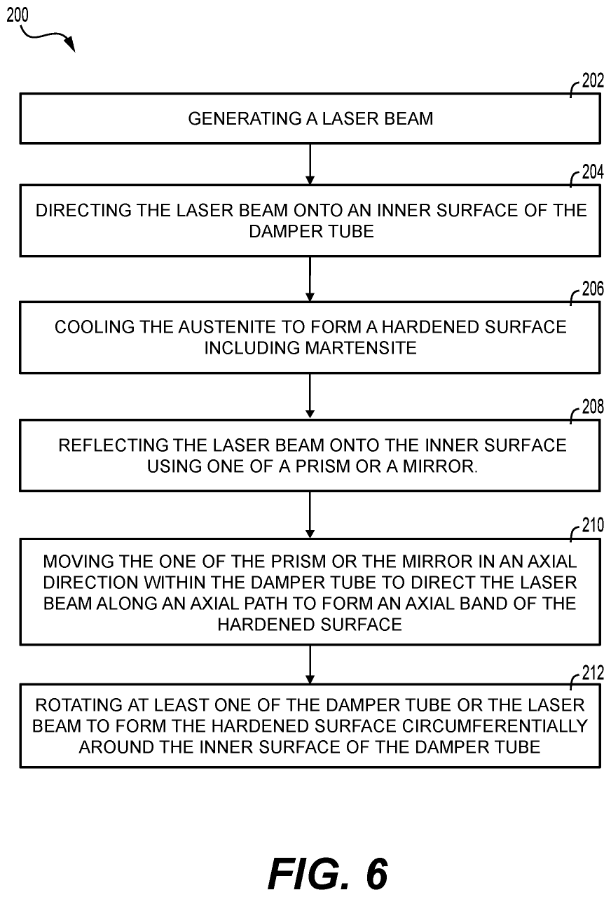

A method 200 for laser hardening a damper tube is shown in the flow chart of FIG. 6. As can be appreciated in light of the disclosure, the order of operation within the method is not limited to the sequential execution as illustrated in FIG. 6, but may be performed in one or more varying orders as applicable and in accordance with the present disclosure.

The method 200 includes generating a laser beam at step 202. For example, the laser source 102 may generate a laser beam with sufficient power to heat a low-carbon steel to form a hardened surface including martensite, and over a time scale that is efficient for production.

The method 200 also includes directing the laser beam onto an inner surface of the damper tube at step 204. Step 204 may include the laser beam heating the inner surface to an elevated temperature sufficient to cause steel of the inner surface of the damper tube to form austenite. For example, directing the laser beam onto the inner surface of the damper tube may include reflecting the laser beam onto the inner surface using one of a prism or a mirror. Directing the laser beam onto the inner surface of the damper tube may include directing the laser beam along a stroke region and less than an axial length of the damper tube.

The method 200 also includes cooling the austenite at step 206 to form a hardened surface including martensite. For example, the austenite may be self-quenched by heat being conducted through the damper tube 22 and away from the heated region. Alternatively or additionally, a supplemental coolant may be used, such as a liquid or a gaseous coolant that may be directed onto a heated portion of the damper tube 22 to remove heat from the bands 60 after the laser heating.

In some embodiments, the method 200 also includes reflecting, at step 208, the laser beam onto the inner surface using one of a prism or a mirror.

In some embodiments, the method 200 also includes moving, at step 210, the one of the prism or the mirror in an axial direction within the damper tube to direct the laser beam along an axial path to form a band of the hardened surface.

In some embodiments, the method 200 also includes rotating, at step 212, at least one of the damper tube or the laser beam to form the hardened surface circumferentially around the inner surface of the damper tube. For example, a rotator actuator 112 may rotate at least one of the damper tube or the laser beam to produce a plurality of the bands 60 spaced apart at regular angular intervals around the inner surface of the damper tube 22.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A damper assembly comprising:
a damper tube having a tubular shape defining an inner surface and extending for an axial length;
a rod disposed at least partially within the damper tube; and
a piston connected to the rod and slidably disposed within the damper tube and configured to contact the inner surface of the damper tube along a stroke region less than the axial length;
wherein the inner surface of the damper tube includes a hardened surface including martensite and extending along the stroke region and less than the axial length of the damper tube.

2. The damper assembly of claim 1, wherein the damper tube is made of low-carbon steel.

3. The damper assembly of claim 1, wherein the hardened surface has a Rockwell Hardness of at least about RC 49.

4. The damper assembly of claim 1, wherein the hardened surface extends circumferentially around the inner surface of the damper tube.

5. The damper assembly of claim 1, wherein the hardened surface includes a plurality of bands that each extend along the stroke region of the inner surface of the damper tube.

6. The damper assembly of claim 5, wherein the plurality of bands are spaced apart at regular angular intervals around the inner surface of the damper tube.

7. The damper assembly of claim 5, wherein the plurality of bands each extend in an axial direction.

8. A method for laser hardening a damper tube, the method comprising:
generating a laser beam;
directing the laser beam onto an inner surface of the damper tube to heat the inner surface to an elevated temperature sufficient to cause steel of the inner surface of the damper tube to form austenite; and
cooling the austenite to form a hardened surface including martensite, and
wherein directing the laser beam onto the inner surface of the damper tube includes directing the laser beam along a stroke region and less than an axial length of the damper tube.

9. The method of claim 8, wherein directing the laser beam onto the inner surface of the damper tube includes reflecting the laser beam onto the inner surface using one of a prism or a mirror.

10. The method of claim 9, wherein the method further includes moving the one of the prism or the mirror in an axial direction within the damper tube to direct the laser beam to form a band of the hardened surface extending along an axial length of the damper tube.

11. The method of claim 8, wherein the method further includes rotating at least one of the damper tube or the laser beam to form the hardened surface circumferentially around the inner surface of the damper tube.

12. The method of claim 11, wherein rotating at least one of the damper tube or the laser beam includes rotating, by a rotator actuator, the damper tube.

13. The method of claim 11, wherein directing the laser beam onto the inner surface of the damper tube includes reflecting the laser beam onto the inner surface using one of a prism or a mirror, and
wherein rotating the damper tube or the laser beam includes rotating the one of the prism or the mirror.

14. The method of claim 8, wherein the hardened surface extends circumferentially around the inner surface of the damper tube.

15. The method of claim 8, wherein directing the laser beam onto the inner surface of the damper tube includes directing the laser beam to form the hardened surface as a plurality of bands that each extend along the stroke region of the inner surface of the damper tube.

16. The method of claim 15, wherein the plurality of bands are spaced apart at regular angular intervals around the inner surface of the damper tube.

17. The method of claim 15, wherein the plurality of bands each extend in an axial direction.

18. The method of claim 8, wherein the damper tube is made of low-carbon steel.

19. The method of claim 8, wherein the hardened surface has a Rockwell Hardness of at least about RC 49.

20. The method of claim 8, wherein the cooling the austenite to form the hardened surface includes self quenching.
